(19) United States
(12) Patent Application Publication
(10) Pub. No.: US 2014/0168375 A1
(43) Pub. Date: Jun. 19, 2014

(54) IMAGE CONVERSION DEVICE, CAMERA, VIDEO SYSTEM, IMAGE CONVERSION METHOD AND RECORDING MEDIUM RECORDING A PROGRAM

(71) Applicants: Atsushi Morimura, Kanagawa (JP); Qinhe Wang, Fukuoka (JP); Mikio Morioka, Fukuoka (JP)

(72) Inventors: Atsushi Morimura, Kanagawa (JP); Qinhe Wang, Fukuoka (JP); Mikio Morioka, Fukuoka (JP)

(73) Assignee: PANASONIC CORPORATION, Osaka (JP)

(21) Appl. No.: 14/234,685

(22) PCT Filed: Jul. 12, 2012
(86) PCT No.: PCT/JP2012/004504

§ 371 Date: Jan. 24, 2014

(30) Foreign Application Priority Data
Jul. 25, 2011 (JP) 2011-161910

(51) Int. Cl. H04N 13/00; H04N 13/02

(52) U.S. Cl. CPC H04N 13/0011; H04N 13/026
USPC 348/46; 348/42

(57) ABSTRACT

Provided are an image conversion device, a camera, a video system, an image conversion method and a program which are capable of performing a desired image conversion even when the orientation of multiple regions within one image is to be changed in different directions. This system is provided with: a region dividing unit (13) which divides one inputted image into multiple regions, and an image conversion unit (14) which converts the image of at least one of the regions created by the region dividing unit (13) to an image imaged from a virtual viewpoint different from the imaging viewpoint of the inputted image.

### TECHNICAL FIELD

The present invention relates to an image conversion apparatus, a camera, a video system, an image conversion method and a recording medium including a program recorded therein that convert an image in such a way that a line-of-sight direction is changed.

### BACKGROUND ART

There has been known a technique that converts an image captured by a camera into an image captured from a virtual viewpoint different from a viewpoint of capturing the original image.

PTL 1 discloses a technique that forms, using the abovementioned image conversion technique, an overview image of a wide range by using a plurality of images captured by a plurality of cameras. In this technique, the plurality of images captured by the plurality of cameras installed at different positions are changed to images captured from the same viewpoint, and the plurality of images are combined into a single image to form the above-described overview image of a wide range.

PTL 2 discloses a technique that is used when an image captured by a main camera includes a blind zone and that fills the blind zone of the image with an image by using the above-described image conversion technique. In this technique, a sub-camera which is different from the main camera is used to capture an image of a range for filling the blind zone. The viewpoint of the captured image is then converted to have the same viewpoint as the viewpoint of the main camera, and the image in the range overlapping with the dead zone is cut out and combined.

### CITATION LIST

### Patent Literature

### PTL 1

### Japanese Patent Application Laid-Open No. 2005-333565

### PTL 2

### Japanese Patent No. 4364471

### SUMMARY OF INVENTION

### Technical Problem

Let us consider a case where a video conference is held, for example, while participants are positioned in three directions of a table and captured by a camera from one remaining direction, and the captured image is output and displayed in a different site for the video conference. In this case, the participant positioned in front of the camera is in a proper display state in which the participant faces the front in the image. However, the participants positioned in the left and right directions of the camera are in a slightly improper display state for the video conference in which the participants turn away from the camera in the image. In this case, the image of all the participants is supposed to be displayed properly if the left region of the image is turned left and the right region of the image is turned right.

However, the image conversion technique that changes a viewpoint according to the related art is a technique that converts an image in a way as if a single whole image is viewed from a single virtual viewpoint. Therefore, the image conversion technique, for example, cannot handle a situation where the right side of the image is turned 30 degrees and the left side of the image is turned 20 degrees.

An object of the present invention is to provide an image conversion apparatus, a camera, a video system, an image conversion method and a recording medium including a program recorded therein that make it possible to flexibly handle a case where one image includes a plurality of regions desired to be turned in different directions and thus to convert the image in a desired way.

### Solution to Problem

An image conversion apparatus according to an aspect of the present invention includes: a region dividing section that divides one input image into a plurality of regions; and an image conversion section that converts an image of at least one of the plurality of regions into an image captured from a virtual viewpoint different from a viewpoint of capturing the input image, the plurality of regions being obtained by dividing the one input image by the region dividing section.

### Advantageous Effects of Invention

According to the present invention, it is possible to convert an image in such a way that one input image is divided into a plurality of regions and a line of sight is changed for each of the regions. Therefore, even in a case where one image includes a plurality of regions desired to be turned in different directions, it is possible to flexibly handle the case.

### BRIEF DESCRIPTION OF DRAWINGS

FIG. 1 is a block diagram illustrating a video conference system including a camera apparatus and displays according to Embodiment 1 of the present invention;

FIG. 2 is a plan view illustrating an example of how images are captured using the camera apparatus according to the embodiment;

FIG. 3 is an image view illustrating a captured image obtained by capturing in FIG. 2;

FIG. 4 is a plan view illustrating line-of-sight directions set by a Line-of-sight setting section;

FIG. 5 is an image view illustrating a captured image after image conversion and image combining processing;

FIG. 6 is a plan view illustrating an example of a display arrangement;

FIG. 7 is a plan view illustrating a variation of the display arrangement;

FIG. 8 is a plan view illustrating a variation of a display configuration;

FIG. 9 is a block diagram illustrating a video conference system including a camera apparatus and displays according to Embodiment 2 of the present invention;

FIG. 10 is a flowchart illustrating a processing procedure of a face direction detecting section;

FIG. 11 is an image view of how face detection is performed;

FIG. 12 is a diagram for describing an example of a detection result of the direction of each face; and

FIG. 13 is a diagram for describing an example of region setting and line of sight setting results.

### DESCRIPTION OF EMBODIMENTS

Hereinafter, embodiments of the present invention will be described based on the drawings.

### Embodiment 1

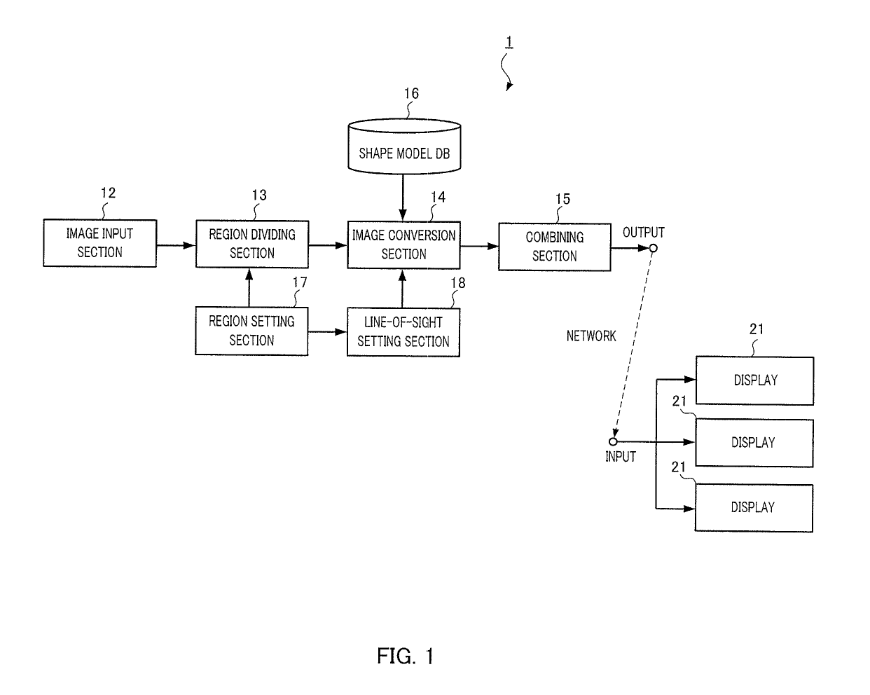

FIG. 1 is a block diagram illustrating a video conference system (video system) including camera apparatus 1 and displays 21 according to Embodiment 1 of the present invention.

Camera apparatus 1 in the embodiment includes: image input section 12 that includes a camera lens and an imaging device and that inputs image data of a captured image; region dividing section 13 that divides the captured image into a plurality of regions; and image conversion section 14 that performs image conversion on the image of each of the regions obtained by the dividing process. In addition, camera apparatus 1 includes: combining section 15 that performs image combining and output; and shape model database 16 that stores therein a three-dimensional shape model of a human face, or shape models of a wall, a desk and the like in a room. Camera apparatus 1 further includes: region setting section 17 that sets a region to be divided; and Line-of-sight setting section 18 that performs setting of the image conversion.

Region setting section 17 has a plurality of operation buttons and sets a plurality of regions in the captured image upon reception of an input operation of a user. For example, optional line segments in the captured image are output and displayed by an input operation of the user, and region setting section 17 sets a range surrounded by the line segments or an outline of the captured image as one region. Alternatively, a plurality of points are input in the captured image by the input operation of the user and region setting section 17 obtains regions divided by dashed lines having the plurality of input points as apexes, or a Voronoi region having the plurality of input points as generators. Then, region setting section 17 may set the Voronoi region as a plurality of regions. The information of the set region is transmitted to region dividing section 13 and Line-of-sight setting section 18.

Upon reception of information on the set regions from region setting section 17, region dividing section 13 performs a dividing process of the image data supplied from image input section 12 so that the captured image is divided into the set regions. Then, region dividing section 13 generates image data for each of the regions and transmits the image data to image conversion section 14.

Line-of-sight setting section 18 has a plurality of operation buttons and sets a line-of-sight direction of a conversion result (direction corresponding to the line of sight after image conversion) with respect to the plurality of regions in the captured image by receiving the input operation of the user. For example, line-of-sight setting section 18 displays an arrow for each of the set regions of the captured image and makes the direction of the arrow changeable in a three-dimensional manner by the input operation of the user. Then, line-of-sight setting section 18 sets the finally determined direction of the arrow as the line-of-sight direction of conversion target. The setting information of the line-of-sight direction for each of the regions is transmitted to image conversion section 14.

Image conversion section 14 performs image conversion processing on the image data of each of the regions so that the image having an optical axis of the camera lens as the line-of-sight direction is converted into an image which is viewed from the line-of-sight direction set for each of the regions. In a case of wide-angle capturing, the line-of-sight directions of the left and right regions of the image are slightly changed from the optical axis of the camera lens according to a viewing angle. Therefore, the information indicating in what shape and how the image before the conversion is placed in a three-dimensional manner is required to accurately perform the image conversion in which the above-described line-of-sight directions are changed. Image conversion section 14 is configured to perform simple image conversion by using the three-dimensional face model for only a face portion of a person requiring accuracy, and handling the other portions as models arranged along a uniform plane. The direction of the uniform plane can be obtained by, for example, extracting a line segment or a polygon which can specify a direction of in the image of each of the regions by an image analysis and estimating an average direction of the line segments or polygons. In addition, image conversion section 14 may be configured to cause the user to input the direction of the plane.

Image conversion section 14 searches for a face portion of a person in the image of each of the regions by matching processing or the like, and when the face portion of the person is present, further specifies the direction of the face from eyes, a nose, a mouth, a contour and the like. Then, image conversion section 14 associates the face image with a three-dimensional shape using the three-dimensional shape data of shape model database 16. In addition, the other portions are associated with the plane in which the direction is estimated as described above. By performing the processing, image conversion section 14 can associate each pixel of the image data with a coordinate point in a virtual three-dimensional mapping space. Next, image conversion section 14 performs processing of converting the image mapped in the virtual three-dimensional space into an image captured from a newly set line-of-sight direction, based on the setting information supplied from line-of-sight setting section 18 to generate image data after conversion. By performing such image processing, image conversion section 14 can convert the image into an image which is viewed from the line-of-sight direction newly set from the line-of-sight direction of the camera during capturing the image of each region so that the face portion of the person is relatively accurately converted and the other portions are roughly converted (to be converted as the plane models).

Combining section 15 arranges the image data of a plurality of regions supplied from image conversion section 14 in the same arrangement as the arrangement when the dividing process is performed, and combines the image data into one piece of image data. The image data is converted into display data for outputting and displaying the image data and is output. When the image data of the plurality of regions obtained by the dividing process is individually output and displayed on a plurality of displays, combining section 15 may be configured to convert the image data of the plurality of regions obtained by the dividing process into display data suitable for the individual displays and output the converted data.

The video conference system in FIG. 1 includes above-described camera apparatus 1, and one or a plurality of displays 21 that output and display an image by receiving display data through a network. For example, in a system including three displays 21, the plurality of displays 21 are set to mainly display and output a plurality of region portions of the display image corresponding to the division regions of the image.

Next, the operation of the above-described video conference system will be described.

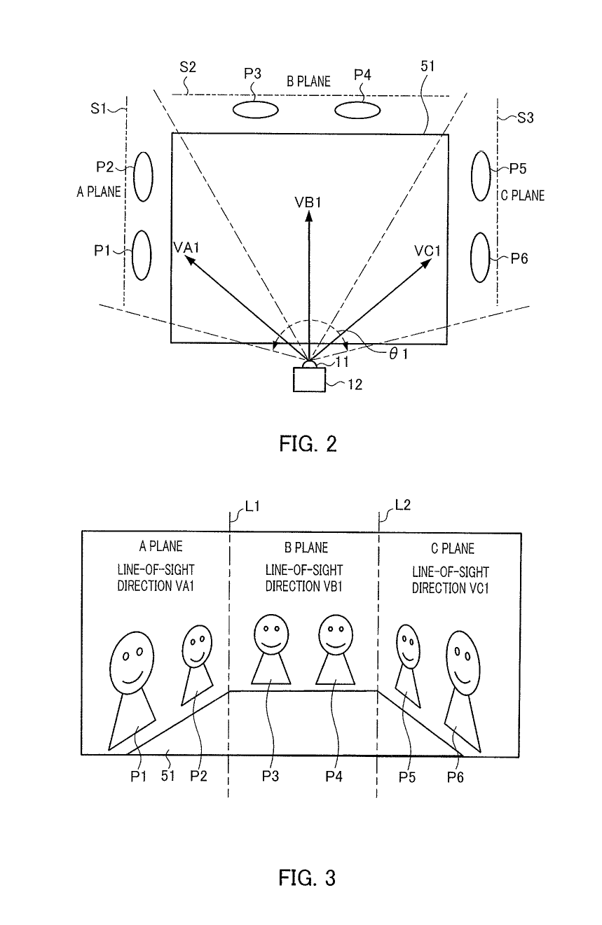

FIG. 2 is a plan view illustrating an example of how an image is captured using camera apparatus 1, FIG. 3 is an image view illustrating a captured image obtained by the capturing in FIG. 2. The example illustrated in FIG. 2 indicates a state in which persons P1 to P6 are positioned in three directions of table 51 and persons P1 to P6 are captured from one remaining direction of table 51 through wide-angle camera lens 11 with wide viewing angle θ1. Such capturing makes it possible to obtain the image as illustrated in FIG. 3.

First, the user sets a region through region setting section 17. Here, as illustrated in FIG. 3, the user designates dividing lines L1 and L2 by region setting section 17 and sets a left side range, a facing surface range and a right side range of table 51 as each region.

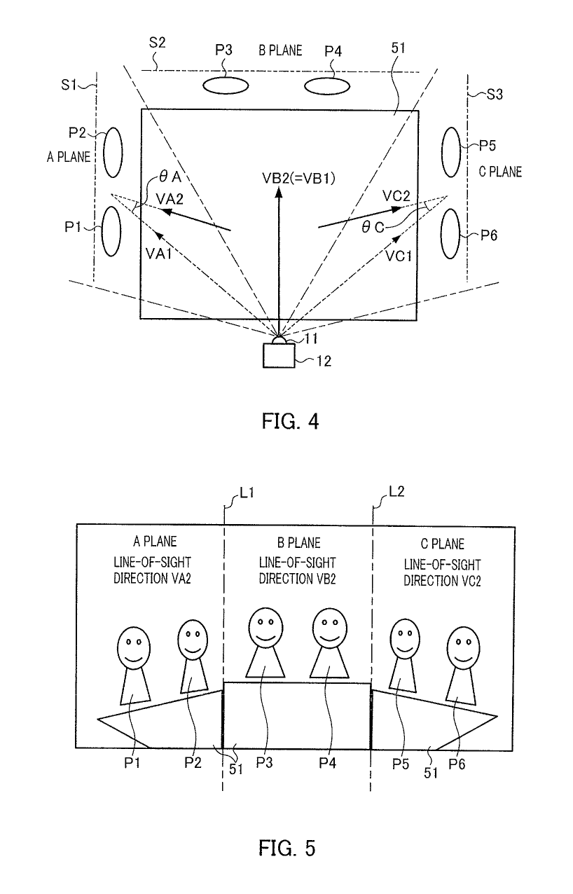

FIG. 4 is a plan view illustrating line-of-sight directions set by the line-of-sight setting section, and FIG. 5 is an image view illustrating a captured image after image conversion and image combining processing.

Next, the user sets a line-of-sight direction to be converted by line-of-sight setting section 18. For example, as illustrated in FIG. 4, the user sets new line-of-sight direction VA2 with respect to line-of-sight direction VA1 of an actual camera in the left region through line-of-sight setting section 18. Further, the user sets line-of-sight direction VB2 which is not changed from the original line-of-sight direction in the center region through line-of-sight setting section 18, and sets new line-of-sight direction VC2 with respect to new line-of-sight direction VC1 of the actual camera in the right region through line-of-sight setting section 18.

Next, image conversion section 14 performs image conversion processing of rotating the image of A plane S1, the three-dimensional shapes of the face portions of persons P1 and P2, and the image of the background wall of the persons by rotational angle “−θA” with respect to the image data of the left region. In addition, image conversion section 14 performs image conversion processing of rotating the image of C plane S3, the three-dimensional shapes of the face portions of persons P5 and P6, and the image of the background wall of the persons by rotational angle “θC” with respect to the image data of the right region. Image conversion section 14 transmits the image data of the center region in which the line-of-sight direction is not changed to combining section 15 without any change.

Then, the image data of such a plurality of regions after conversion is combined by combining section 15 to generate an image as illustrated in FIG. 5. In the image illustrated in FIG. 5, the images of persons P1 and P2 positioned on the left side of table 51 and persons P5 and P6 positioned on the right side are converted into images directed approximately to the front, and the depth perception of the images is also converted to the same degree as in the images before conversion so that the images are changed into images which are easily viewable in the video conference.

When the above-described combining processing is performed, combining section 15 may perform smoothing processing of smoothing boundaries between the images of the regions, or processing of matching a position of a characteristic object. For example, in the case of FIG. 5, table 51 is set as the characteristic object, and combining section 15 may move the entire image of the A plane vertically to match the end position of the table. In addition, combining section 15 may remove the upper and lower regions of the entire image to make an empty region invisible from the user by moving the image and perform combining processing so that the entire image has a rectangular shape.

Since combining section 15 makes the image data of each region converted by image conversion section 14 have the same size (shape) as the image data before conversion and combines the image data, combining section 15 selects a region to be used in the image data after conversion, and then, combines the image data. In the image data after conversion, when there is a portion in which the size is not sufficient, combining section 15 may be configured to perform right and left inversion (make a mirror image) on a neighboring image as image data used for the insufficient portion.

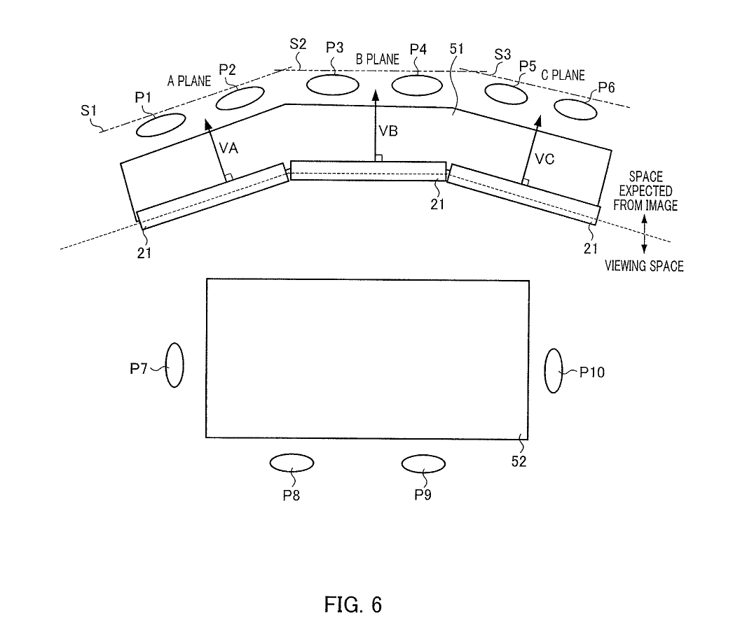

FIG. 6 is a plan view illustrating an arrangement example of a plurality of displays 21. In the drawing, reference numeral 52 denotes a table in a video conference room, and reference numerals P7 to P10 respectively denote persons in the meeting room. Further, a lower side of a dotted line illustrates a viewing space in a connection source (current room), and an upper side of the dotted line illustrates a space image in a room of a connection destination which is expected from the image.

On the side of viewing the image transmitted from camera apparatus 1, as illustrated in FIG. 6, displays 21 with the same number as the number of the division regions of the image are arranged in the same arrangement as the arrangement of the division regions. At this time, directions VA, VB and VC of each display 21 are arranged to correspond to line-of-sight directions VA2, VB2 and VC2 after conversion in the image of each of the regions. Alternatively, the information on the directions of displays 21 is transmitted to camera apparatus 1, and line-of-sight directions VA2, VB2 and VC2 of new conversion results corresponding to the information may be set in camera apparatus 1.

Then, the image data mainly including the corresponding image of each region is output and displayed on each display 21. When combining section 15 determines displays 21 of output and display destinations, combining section 15 may refer to the arrangement information of each display 21 and the position information of each division region in the image. Then, combining section 15 transmits the image data including the division regions corresponding to the arrangement information of corresponding displays 21 to each display 21.

By outputting the images from a plurality of displays 21, as illustrated in FIG. 6, the directions and arrangement of persons P1 to P6 as partners of the video conference expected from the images and table 51 are converted to be properly widened (viewed as the direction is changed from the side direction to the front direction). Therefore, the partners of the video conference are easily viewable.

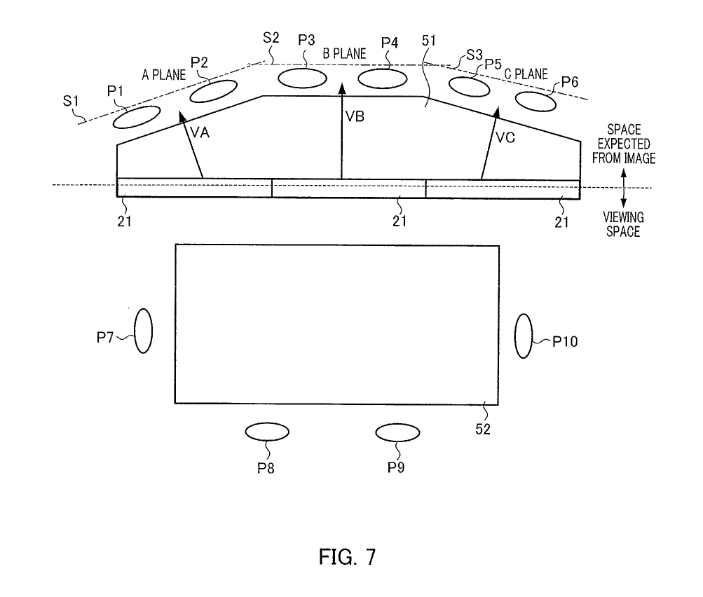

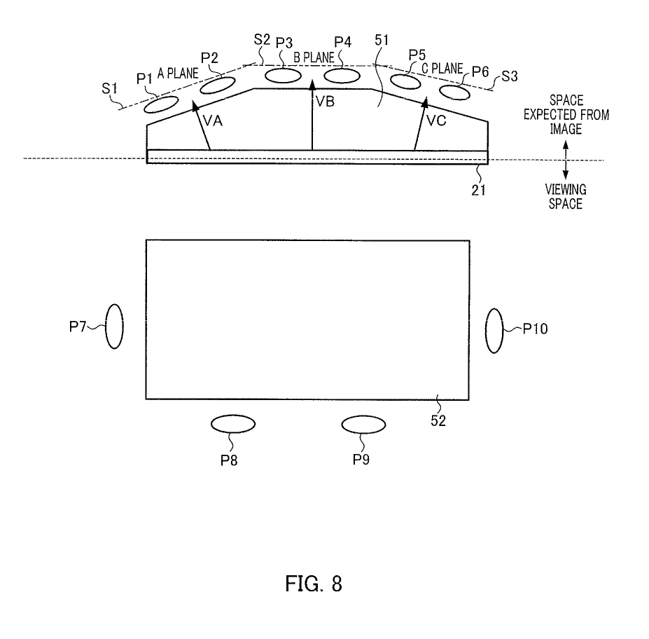

FIGS. 7 and 8 are plan views each illustrating a variation of the number and arrangement of displays 21. A plurality of displays 21 illustrated in FIG. 7 are arranged on the plane without any change in angle. In the arrangement, angle differences between vertical lines of screen planes of displays 21 and line-of-sight directions after conversion corresponding to the easily viewable directions VA, VB and VC may be added to the conversion angles θA and θB of the line-of-sight directions. Even when displays 21 are planarly arranged in this manner, almost similar to the case of FIG. 6, the images of the partners of the video conference can be output and displayed in an easily viewable manner. In addition, as illustrated in FIG. 8, the images of all of the division regions may be collectively displayed by single display 21. In this manner, almost similar to the case of FIG. 6, the images of the partners of the video conference can be output and displayed in an easily viewable manner.

### Embodiment 2

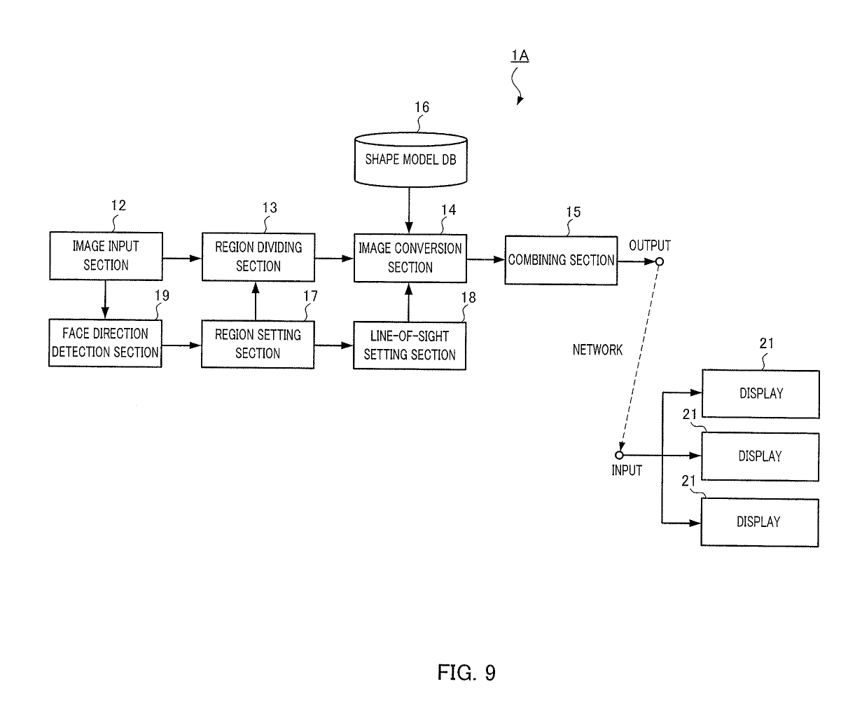

FIG. 9 is a block diagram illustrating a video conference system including camera apparatus 1A and displays 21 according to Embodiment 2. Camera apparatus 1A according to Embodiment 2 automatically performs, by processing of face direction detection section 19, region setting in an image by region setting section 17, and new line-of-sight direction setting by line-of-sight setting section 18.

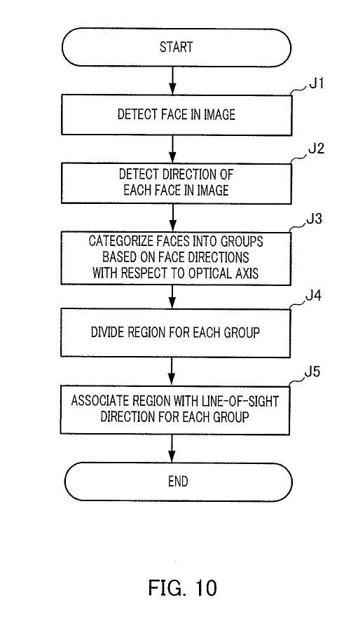

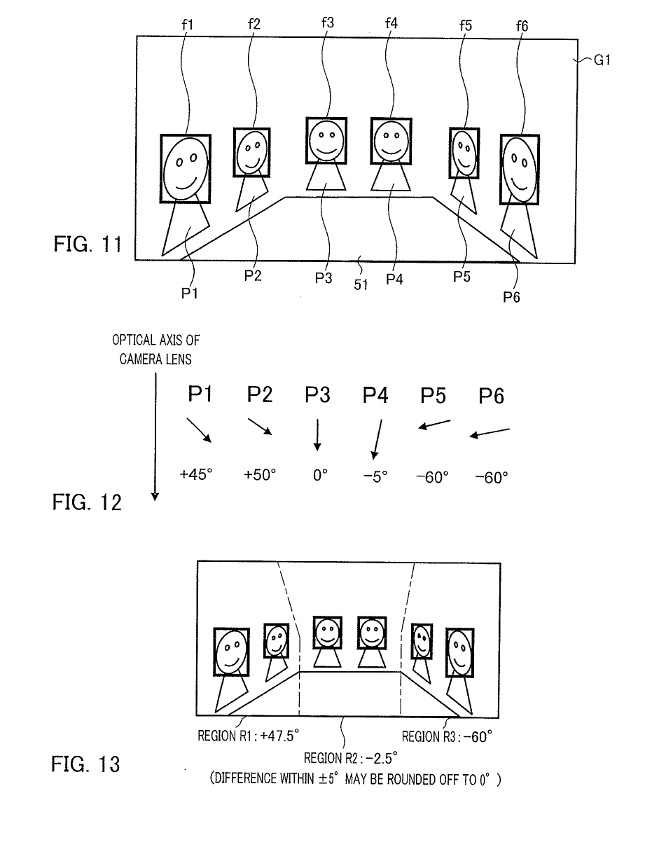

FIG. 10 is a flowchart illustrating a processing procedure of face direction detection section 19; FIG. 11 is an image view for describing face detection; FIG. 12 is a diagram for describing an example of a detection result of the direction of each face; and FIG. 13 is a diagram for describing an example of region setting and line of sight setting results.

For example, face direction detection section 19 starts processing of the flowchart illustrated in FIG. 10 based on an instruction operation for starting settings from a user. The user performs the instruction operation for starting settings in a state in which persons are positioned and a capturing frame is determined.

When the processing starts, first, face direction detection section 19 acquires the captured image at this point from image input section 12 to detect a face portion of a person in the captured image by matching processing (Step J1: image search processing). As shown in FIG. 11, from image G1 in which table 51 and persons P1 to P6 are captured, detection frames f1 to f6 of the face portions of persons P1 to P6 are extracted.

Next, face direction detection section 19 analyzes the contours of the detected face portions and the arrangement of eyes, a nose and a mouth to detect direction of each face (Step J2: direction detection processing). As illustrated in FIG. 12, the face direction of each of persons P1 to P6 of image G1 is detected and is digitalized from the relationship between the position of the camera lens and the direction of each face.

Next, face direction detection section 19 categorizes the plurality of faces into groups (Step J3) based on the positions of the detected faces and the directions of the detected faces in the image. Specifically, face direction detection section 19 groups a plurality of faces in which a difference in the directions of the detected faces is within a predetermined range (for example, within 30°) and the positions of the detected faces are arranged in sequence. In the case of image G1, since a difference between the face directions of two persons P1 and P2 consecutively positioned from the left side is within 30°, and a difference between the face direction of person P3 who is the third person next to person P2 and the face direction of person P2 exceeds 30°, face direction detection section 19 categorizes the faces in detection frames f1 and f2 into a first group. By repeating the same processing, face direction detection section 19 categorizes the faces in detection frames f3 and f4 into a second group and categorizes the faces in detection frames f5 and f6 into a third group.

After arranging the faces into the groups, face direction detection section 19 divides the image into regions corresponding to each group (Step J4: region setting processing). The dividing process of a region can be performed by, for example, using a Voronoi division algorithm. That is, face direction detection section 19 performs dividing process of a region for each face using the center of each of the detected faces as a generator so that each point on the image belongs to the closest generator. Further, face direction detection section 19 combines the regions of the plurality of faces belonging to the same group to set the regions to regions R1 to R3 of the corresponding groups (refer to FIG. 13). Regions R1 to R3 for each group are determined and then, face direction detection section 19 transmits the information of regions R1 to R3 to region setting section 17 to perform region setting.

After the dividing process of a region, face direction detection section 19 performs processing of determining a line-of-sight direction of conversion result for each group (Step J5: line of sight setting processing). As illustrated in FIG. 13, the line-of-sight direction is obtained as an average direction of the directions of the plurality of faces belonging to the same group. The obtained line-of-sight directions are associated with regions R1 to R3 for each group and transmitted to line-of-sight setting section 18. Therefore, the line-of-sight direction of the conversion result of each of regions R1 to R3 is set in Line-of-sight setting section 18. When the line-of-sight direction is changed only by a small angle (for example, ±5°) from the line-of-sight direction connecting the center point of each of regions R1 to R3 and the camera, an image conversion may be omitted, and the line-of-sight direction of the conversion destination is not set in this case.

In Embodiment 2, the operations are performed in the same manner as in Embodiment 1 except the region setting of the image and new line-of-sight direction setting. In Embodiment 2, the input operation of the user required for the region setting and the new line-of-sight direction setting can be considerably reduced.

As described above, in camera apparatuses 1 and 1A according to Embodiments 1 and 2, and the video conference system, image conversion processing can be performed on one input image by dividing the image into a plurality of regions and converting the division images into images having different line-of-sight directions, respectively. According to this system, when one input image includes a plurality of subjects directed in various directions, the arrangement and the directions of the subjects are flexibly handled, and the image can be converted into an easily viewable image as a whole. Alternatively, the image can be converted into an image that has been deformed in a desired way in various aspects.

In the above-described embodiments, an example in which the video system of the present invention is applied to a video conference system has been described, but the configuration of the video system may be implemented in one digital still camera or one digital video camera. That is, the configuration to input an image, to divide an image into a plurality of regions, to perform image conversion for changing a line-of-sight direction, and to output and display an image may be included and performed in one apparatus. In addition, an apparatus obtained by removing image input section 12 from camera apparatuses 1 and 1A in the embodiments may be separately provided as an image conversion apparatus.

Further, in Embodiment 2, an example in which image conversion is performed by categorizing a plurality of faces into groups and changing a line-of-sight direction in each region of each group has been described. However, the image conversion section may be configured to set each of face detection frames f1 to f6 as an individual region and to individually perform image conversion (line-of-sight direction conversion) only on the face portions.

In addition, line-of-sight direction conversion may be performed on the background portions according to the angles of the faces. Since a camera image is used as input and there is no image data of lateral side and back side unlike CG in the line-of-sight direction conversion, a modest conversion (with a degree smaller than the degree of an expected conversion) may be suitable in some cases. In particular, when the conversion angle exceeds 30° C., the modest conversion may be performed.

In addition, line-of-sight setting section 18 does not necessarily change all the lines of sight. The line-of-sight setting section may be configured to convert a viewpoint of one region and to maintain the original viewpoints without performing viewpoint conversion for the other regions. As a result, the line-of-sight setting may be performed such that two lines of sight are relatively changed.

Further, region setting section 17, line-of-sight setting section 18, and face direction detection section 19 are not necessarily included in camera apparatus 1 (or camera apparatus 1A), and these functions may be provided through a network. For example, the video conference apparatus of the connection destination of the video conference system includes the image input section, the region dividing section, the image conversion section, the shape model DB, and the combining section. In addition, the video conference apparatus of the connection source includes the region setting section, the line-of-sight setting section, and the face direction detection section. Then, the video conference apparatus of the connection source may receive an image from the video conference apparatus of the connection destination through the network, perform region setting, line-of-sight direction setting and face detection, and transmit the results to the video conference system of the connection destination so that a desired image is obtained.

The configuration elements including region dividing section 13, image conversion section 14, combining section 15, region setting section 17, line-of-sight setting section 18, and face direction detection section 19, which have been described in the above-described embodiments, may be configured by hardware, or software which is implemented by a program executed by a computer. The program may be recorded in a computer readable recording medium. The recording medium may be a non-transitory recording medium such as flash memory and the like.

The disclosure of Japanese Patent Application No. 2011-161910, filed on Jul. 25, 2011, including the specification, drawings and abstract, is incorporated herein by reference in its entirety.

### INDUSTRIAL APPLICABILITY

The present invention can be applied to a digital still camera, a digital video camera, and a video system which transmits or broadcasts video to a different place to allow for viewing the video.

### REFERENCE SIGNS LIST

1, 1A Camera apparatus
12 Image input section
13 Region dividing section
14 Image conversion section
15 Combining section
16 Shape model database
17 Region setting section
18 Line-of-sight setting section
21 Display
VA1 to VC1 Line-of-sight direction of actual camera
VA2 to VC2 Line-of-sight direction of conversion result

1. An image conversion apparatus comprising:
a region dividing section that divides one input image into a plurality of regions; and
an image conversion section that converts an image of at least one of the plurality of regions into an image captured from a virtual viewpoint different from a viewpoint of capturing the input image, the plurality of regions being obtained by dividing the one input image by the region dividing section.

2. The image conversion apparatus according to claim 1, wherein the virtual viewpoint used when the image conversion section converts the image is different from a viewpoint of an image of at least another one of the plurality of regions.

3. The image conversion apparatus according to claim 1, further comprising an output section that outputs the images of the plurality of regions as image data while a positional relationship between the plurality of regions is maintained, the images of the plurality of regions being obtained by converting the images by the image conversion section.

4. The image conversion apparatus according to claim 1, further comprising:
an image search section that searches for a predetermined target object in the input image; and
a region setting section that determines, based on a position of the target object found by the image search section, the plurality of regions to be obtained by dividing the input image by the region dividing section.

5. The image conversion apparatus according to claim 4, further comprising:
a direction detection section that detects a direction of the target object found by the image search section; and
a line-of-sight setting section that determines a line of sight of a conversion result in the image of each of the regions based on the direction of the target object detected by the direction detection section, wherein
the image conversion section converts the image of each of the regions according to the line of sight determined by the line-of-sight setting section.

6. The image conversion apparatus according to claim 4, wherein the target object is a face portion of a person.

7. A camera comprising:
a capturing section that includes a lens configured to form an image of a subject and an imaging device configured to convert an optical image formed by the lens into an electrical signal and that obtains a captured image; and
the image conversion apparatus according to claim 1 that has the captured image as the input image.

8. A video system comprising:
the camera according to claim 7; and
a plurality of display sections that respectively output and display the images of the plurality of regions obtained by converting the images by the image conversion section.

9. An image conversion method comprising:
dividing one input image into a plurality of regions; and
converting an image of at least one of the plurality of regions into an image captured from a virtual viewpoint different from a viewpoint of the input image, the plurality of regions being obtained by dividing the one input image.

10. A computer readable recording medium in which a program is recorded, the program causing a computer to execute functions comprising:
dividing one input image into a plurality of regions; and
converting an image of at least one of the plurality of regions into an image captured from a virtual viewpoint different from a viewpoint of the input image, the plurality of regions being obtained by dividing the one input image.
